(19) United States
(12) Patent Application Publication
(10) Pub. No.: US 2006/0084041 A1
(43) Pub. Date: Apr. 20, 2006

(54) Diary type language-learning system

(76) Inventors: Chih-Ming Lin, Hsinchu (TW); Cheng-Kuo Huang, Kaohsiung (TW)

Correspondence Address: BACON & THOMAS, PLLC, 625 SLATERS LANE, FOURTH FLOOR, ALEXANDRIA, VA, 22314, US

(21) Appl. No.: 10/968,158

(22) Filed: Oct. 20, 2004

(51) Int. Cl. G09B 17/00

(52) U.S. Cl. 434/178

(57) ABSTRACT

The present invention relates to a diary type language learning system that is capable of creating a vivid daily language-learning environment by using the network and the computer. The authors can provide their daily diary for the readers to read via the network, thus creating a day-to-day language situation. The diary type language learning system comprises: a learning platform, which is a host computer with broadband networking capability and is built up in a network, so as to create a website and a mailer server; a plurality of authors serves to supply diary to the learning platform through the network; a plurality of readers selectively read the diary on the platform via the network.

### FIELD OF THE INVENTION

The present invention relates to a language learning system, and more particularly to a diary type language-learning system based on the network and the computer.

### BACKGROUND OF THE INVENTION

Today, English-learning is becoming more and more popular around the world, all kinds of books for English-learning are emerging in quick succession. However, none of these books can provide a vivid language environment, thus, making the learner feel bored and find it pretty difficult to make progress.

When a child starts to learn a native language, his parents, sisters and brothers will speak to him and correct his mistakes from time to time in his daily life, naturally the child can catch the know-how and master the native language gradually and easily.

The boundless internet can create a daily English-language environment for the learners and enable them to find out the real material that they want to study in real life, through this way, the learner can achieve more with less effort.

The present invention has arisen to mitigate and/or obviate the afore-described disadvantages.

### SUMMARY OF THE INVENTION

The primary object of the present invention is to provide a diary type language learning system capable of creating a vivid daily language-learning environment by using the network and the computer. The authors can provide their daily diary for the readers to read via the internet, thus creating a day-to-day language situation.

The diary type language learning system in accordance with the present invention comprises:

a learning platform, which is a host computer with broadband networking capability and is built up in a network, so as to create a website and a mailer server;

a plurality of authors serves to supply diary to the learning platform through the network;

a plurality of readers selectively read the diary on the platform via the network.

The present invention will become more obvious from the following description when taken in connection with the accompanying drawings, which show, for purpose of illustrations only, the preferred embodiment in accordance with the present invention.

### BRIEF DESCRIPTION OF THE DRAWINGS

FIG. 1 is a frame chart for a diary type language-learning system in accordance with the present invention;

FIG. 2 is a frame chart for showing the software used on the learning platform;

FIG. 3 is a flow chart for showing how to use the language learning system of the present invention.

### DETAILED DESCRIPTION OF THE PREFERRED EMBODIMENT

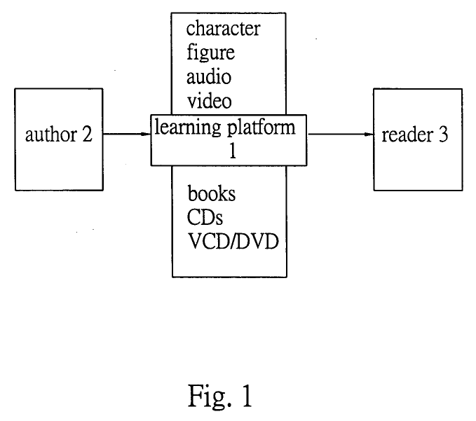

Referring to FIG. 1, which is a frame chart for a diary type language-learning system in accordance with the present invention. A learning platform 1 is set up on the Internet or a local area network (LAN) so as to create a website. The author 2 and the reader 3 of the diary can communicate with each other via the Internet or the LAN.

The learning platform 1 is basically a host computer having broadband networking capability, and the learning platform is made with MS Windows or Linux operating system, IIS or Apache web server, MS SQL or MySQL database, MS IIS SMTP or Qmail/Sendmail mail server, and is developed with ASP, PHP program or any kind of script programming language.

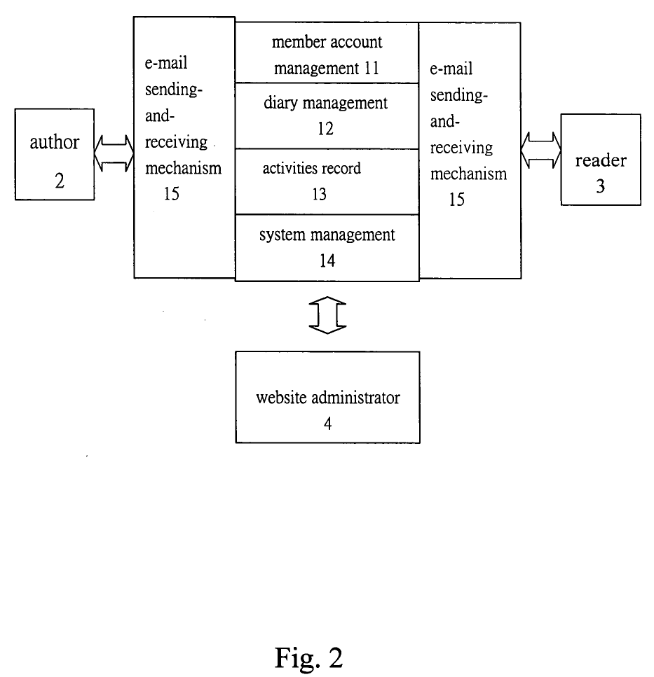

The frame of the software on the learning platform 1 is shown in FIG. 2 and generally comprising: member account management 11, dairy management 12, activities record 13, system management 14 and E-mail sending-and-receiving mechanism 15.

The member account management 11 basically serves to manage the basic data for the registered member (the reader 3), such as which group the member belongs to, the limits of authority and account number, etc.

The diary management 12 serves to receive, process, and save the diary provided by the author 2, then providing the diary including the author's information for the registered member (the reader 3).

The activities record 13 serves to record the registered member's login and logout and to record the data for each diary, for example, the number of people and the time at which they read, the best-reading list, and the number of people visit the website each day.

The system management 14 enables the website administrator 4 to publish notice and answer the questions of the members, etc.

The E-mail sending-and-receiving mechanism 15 serves to send daily diary to the registered member, publishing system notice, sending out confirmation after registration, and to notice the registered member before the due date of the account.

The author 2 of the diary is a diary provider invited or employed by the administrator 4 and serves to send the finished diary to the learning platform 1 via the Internet or a LAN. After being processed by the administrator 4, the diary is put on the website for the registered member to read. The process means that the administrator 4 employs experts to check against the authoritative text, annotate and translate, etc.

The dairy data on the learning platform 1 includes not only characters but also the composition of figures, audio and video (as shown in FIG. 1). This composition can be designed by the author 2 and then submitted via the Internet, or can be redesigned and recomposed by the experts employed by the administrator 4. Thus creating a lifesome language situation, and this is the characteristic of the diary type language-learning system of the present invention.

The diary data on the learning platform 1, after being processed, can be published as a book or CD for the reader 3 to buy.

The contents of the diary are all-inclusive, including the kid, the student and the adult's daily living situations. The author 2 will become a social icon if his/her diary is popular, and of course he/she will be paid, the more readers he/she has, the more prosperous and famous he/she will be.

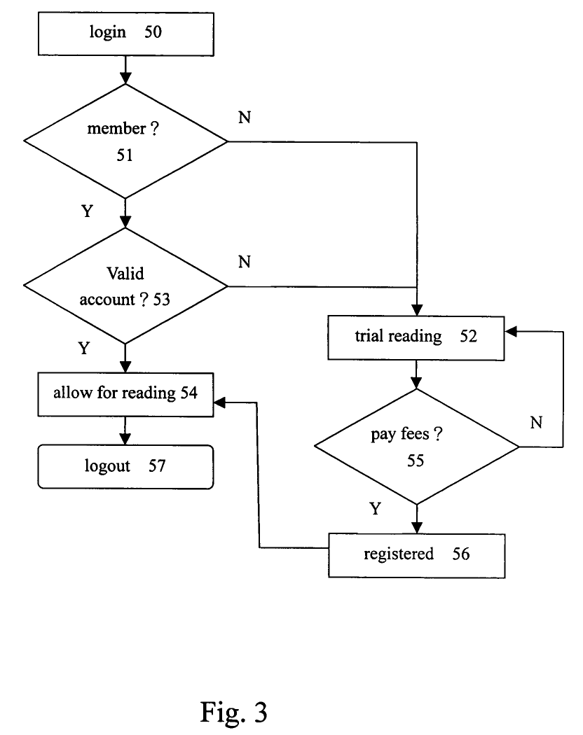

FIG. 3 is a flow chart for showing how to use the language learning system of the present invention. Firstly a reader 3 will be inquired whether he/she is a member 51 when login the website 50. Then the reader 3 is only permitted to access the trial reading room 52 if he/she is not a member 51, and if the reader 3 is a member, he/she will be checked if his/her account is valid 53. If his/her account is overdue, the reader 3 is permitted to access the trial reading room 52 only. If the account is valid, the reader is allowed to read the content of the diary 54, and then logout after finishing reading the diary 57. When accessing the trial reading room 52, the reader 3 will be inquired whether he/she wants to pay membership fee or not 55, and the reader 3 will become a registered member 56 after paying the fee and then will be allowed to read the content of the diary 54. If the reader 3 doesn't pay, he/she only can stay in the trial reading room 52.

The diary type language learning system in accordance with the present invention includes, but is not limited to English-learning system, any two languages can use this system for teaching and learning.

While we have shown and described various embodiments in accordance with the present invention, it should be clear to those skilled in the art that further embodiments may be made without departing from the scope of the present invention.

What is claimed is:

1. A diary type language learning system, comprising:
a learning platform, which is a host computer with broadband networking capability and is built up in a network, so as to create a website and a mailer server;
a plurality of authors serving to supply diary to the learning platform through the network;
a plurality of readers selectively reading the diary on the platform via the network.

2. The diary type language learning system as claimed in claim 1, wherein the network is an Internet or a Local Area Network.

3. The diary type language learning system as claimed in claim 1, whereon the learning platform is made with MS Windows or Linux operating system, IIS or Apache web server, MS SQL or MySQL database, MS IIS SMTP or Qmail/Sendmail mail server, and is developed with ASP, PHP program or any kind of script programming language.

4. The diary type language learning system as claimed in claim 1, wherein software used in the platform includes: member account management, dairy management, activities record, system management and E-mail sending-and-receiving mechanism.

5. The diary type language learning system as claimed in claim 1, wherein the author is a diary provider invited or employed by an administrator and serve to send a finished diary to the learning platform via the Internet or the LAN, after being processed by the website, the diary is put on the website for the registered member to read, the process of the website means that the administrator employs experts to check against the authoritative text, annotate and translate, etc.

6. The diary type language learning system as claimed in claim 1, wherein data of the dairy on the learning platform includes not only characters but also a composition of figures, audio and video, thus creating a vivid language situation.

7. The diary type language learning system as claimed in claim 1, wherein the diary can be written in any languages, and also can be translated into other languages according to the reader's needs, and the translated diary can be displayed together with its original version by the learning platform for the readers to read.
